(19) United States
(12) Patent Application Publication
(10) Pub. No.: US 2009/0205300 A1
(43) Pub. Date: Aug. 20, 2009

(54) FILTER ELEMENT AND ARRANGEMENT

(75) Inventors: Peter Pfeuffer, Ketsch (DE); Rainer Kaffenberger, Reichelsheim (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/279,599

(22) PCT Filed: Feb. 2, 2007
(86) PCT No.: PCT/EP2007/000905

§ 371 Date: Nov. 19, 2008

(30) Foreign Application Priority Data
Feb. 15, 2006 (DE) 10 2006 007 182.4

(51) Int. Cl. B01D 46/06; B01D 46/52

(52) U.S. Cl. 55/365

(57) ABSTRACT

A filter element comprising a first planar layer (1) and a second planar layer (2), the layers (1, 2) being joined to one another to form at least one volume and at least one opening (3), and the layers (1, 2) being spaced apart from one another in places by means (4). With regard to the object of providing a filter assembly which is easily manufactured and ensures proper operation, the invention is characterized in that the means (4) are formed from at least one layer (1, 2). An assembly comprising a filter element and a frame is also described. Also described is a layer (1, 2) having deep-drawn areas.

### FIELD OF THE INVENTION

The invention relates to a filter element comprising a first planar layer and a second planar layer, the layers being joined to one another to form at least one volume and at least one opening, and the layers being spaced apart from one another in places by means. The invention further relates to an assembly comprising a filter element and a frame, and also relates to a layer.

### BACKGROUND INFORMATION

Such filter elements and assemblies are known from the prior art. The category-defining filter elements are used as bag filters provided in air conditioners and ventilation devices. These bag filters have means which space the layers from one another and prevent the layers from coming into contact with one another, which would adversely affect the filtering effect. The means are typically designed in the form of strips, having two layers joined by a seam, and in the region of the opening in the bag filter have a slit which allows the bag filter to expand in the opening region.

In this manner the filter element may be expanded in the region of the opening, whereas the filter element tapers toward the end of the filter element facing away from the opening. This ensures that an air stream is able to penetrate a large area of a wedge-shaped filter element and be filtered.

However, for the category-defining filter elements it is disadvantageous that provision of the strip-shaped means requires complicated operating steps. This significantly increases the costs of the manufacturing process for the known bag filters. It is also disadvantageous that the strip-shaped means may tear or become detached from a layer during manufacture and operation. A detached strip-shaped means disadvantageously changes the flow characteristics within the bag filter during operation when the means moves around loose, in a manner of speaking, inside the bag filter.

### SUMMARY OF THE INVENTION

The object of the invention, therefore, is to provide a filter assembly which is easily manufactured and ensures proper operation.

The referenced object is achieved according to the invention by the features of claim 1. According to claim 1, a filter element of the type described at the outset is characterized in that the means are formed from at least one layer.

According to the invention it has been found that separate strip-shaped means may be omitted when the means are formed from the layer itself. In this manner the means may advantageously remain secured to the layers during operation, and cannot become detached therefrom. This ensures that over the entire operating life of the bag filter the flow characteristics are not adversely affected as the result of means moving around loose. A bag filter may also be economically manufactured, since the spaced means may be easily formed from the layers which are used. In this manner a filter assembly may be implemented which is easily manufactured and ensures proper operation.

The above-referenced object is achieved as described below.

In one embodiment having a particularly favorable design, the means may be formed from both layers. This allows creation of a particularly large volume and a reliable spacing of the layers from one another. In this manner chambers may be provided between two layers which have a particularly large internal width, thereby easily forming channels which allow flow to pass through.

In a further embodiment the means may join the layers to one another, at least in places. This ensures that the means separate two chambers, formed inside the layers, from one another in a flow-tight manner. In this regard it is possible for the layers not to be joined in the region of the opening, thereby preventing expansion of the filter element in the region of the opening. The layers may be joined together using an adhesive process or thermal processes. An adhesive process allows the use of flexible adhesives which have sufficient flexibility even after curing. As the result of using such an adhesive, it is advantageous that the adhesion sites are not damaged even when the filter element is twisted or deformed. Thermal bonding of the layers, for example by melting thermoplastic portions of the layers, allows particularly rapid manufacture of the filter element. Adhesive bonding or welding of the layers also increases the rigidity thereof, thus improving the flow characteristics of the filter element.

The means may be designed as deep-drawn or embossed areas. A deep-drawing process allows formation of structures within the layer itself. During deep-drawing, material is heated and shaped. Deep-drawing processes allow reinforcement of the layers, so that the produced filter element has a high intrinsic rigidity and therefore may be easily inserted into borders or cavities. In addition, the layers are spaced apart continuously, i.e., not just in the flowthrough state, and easily allow penetration of a liquid stream. The strip-shaped means known from the prior art are not able to achieve this effect of continuously spacing the layers at a minimum distance apart, so that during operation the fluid stream passing through must first separate the layers from one another in order to enter the volume formed by the layers. This results in disadvantageous, undesired flow characteristics of the filter element.

The means may also be designed as embossed areas. The embossments may include ribs or other structures, which are imprinted on the layer in particular by thermal processes. In this regard it is possible to produce the embossed areas using ultrasonic horns or heated embossing rollers.

The means may be designed as planar elements. Provision of planar elements allows simple manufacture and the formation of defined air flow channels within the filter element. The formation of channels allows directed, turbulence-free guiding of an air stream which is to be filtered.

The means may be designed as three-dimensional structures which project from a flat, planar layer. This particular design allows setting of the internal width of the chambers provided between the layers. Chambers or channels of any given cross-sectional shape may be provided solely as a function of the size or geometric shape of the structures. It is even possible to design the three-dimensional structures in such a way that they result in tapering of the chambers or channels in the direction of flow.

The means may have a curved shape. This particular design is advantageous for manufacture of the filter element, since a curved shape may be easily introduced into a planar layer using heatable rollers or roller assemblies. A planar layer may be imprinted with curved structures in particular by the fact that two embossing platforms having projecting, heatable oblong elements which have rounded, curved surfaces incorporate the layer in between. The oblong elements stretch or pull the layer into interspaces formed between the elements, which are situated in an offset manner. The heated elements heat and shape, i.e., deform, thermoplastic fibrous material. The deformation is “frozen in,” in a manner of speaking, after the fibrous material is chilled. In this manner an undulating or curved pattern is associated with the layer by means of a deep-drawing process. Furthermore, the curved shape is advantageous since two layers having curved means may define channels which have a circular or ellipsoidal cross section. This geometric shape results in particularly favorable flow characteristics.

The layers may be produced from nonwoven fabric. The nonwoven fabric may be composed of staple fibers, nanofibers, microfibers, or electrostatically charged fibers. The use of a nonwoven fabric allows particularly good filtering efficiencies, since due to its adjustable porosity a nonwoven fabric may be adapted to various requirements. The nonwoven fabric may include thermoplastic fibers. In this regard it is possible for the nonwoven fabric to have only a defined proportion of thermoplastic fibers which is sufficient to impart a structure or intrinsic rigidity to the layers by thermal treatment.

The provision of thermoplastic fibers allows a layer to be thermally embossed or deep-drawn, and allows dimensionally stability to be imparted when the thermoplastic fibers recrystallize or solidify. In this regard, the filter elements may be manufactured by first subjecting one layer, as a semifinished product, to a thermal process, and then combining with an additional layer which may be designed as an identical part.

In this regard the nonwoven fabric may contain activated carbon or activated carbon granules, or one or more layers containing activated carbon or activated carbon granules may be associated with the nonwoven fabric. This particular design allows unpleasant odors or gaseous impurities to be filtered from the air stream. This embodiment could be used in particular in air conditioner assemblies of buildings, ships, or automobiles, which place high demands on the quality of the interior environment.

The layers may have a rectangular or trapezoidal shape, and may be joined together at three sides. This embodiment ensures a particularly simple design of the filter element. This also allows a bag-like, wedge-shaped structure to be achieved in which an air volume may be captured for filtering.

The layers and/or means may be welded together. In a welding process, the materials of which the layers are composed are melted or fused, thus allowing individual material layers to flow into one another. This could also be achieved by ultrasonic welding. This particular design allows particularly secure bonding of nonwoven fabrics to one another. In addition, a seam produced by ultrasonic welding is usually characterized in that it has an increased material density, so that it is able to impart stability to the filter element. An ultrasonically welded seam also ensures a particular gas-tightness in the region of the seam. Multiple seams may be provided solely as a function of the desired stability to impart increased stability to the filter element in places. In particular, it is possible for the ultrasonically welded seams to function as support elements.

In this regard the layers and/or means may also be joined together by laser welding. A laser welding process is characterized in that seams may be produced in a particularly precise and rapid manner. A laser welding process may also be used for affixing different parts of the filter element to one another at specific points.

Welding processes which are carried out using microwaves or other electromagnetic high-frequency waves are also possible. These processes allow very rapid heating of material to be welded, as well as simple metering of energy applied to the material.

The layers may be adhesively bonded to one another. Use of an adhesive which is flexible after curing is possible, thus allowing the filter element to be deformed during insertion into installation spaces without being destroyed. An adhesive process may be carried out economically, and achieves a high degree of gas-tightness at the adhesion sites.

The object referenced above is further achieved by the features of claim 14.

To avoid repetition, with regard to inventive step reference is made to the discussion of the filter element as such.

The frame and the filter element may be detachably joined to one another, thus allowing a stable assembly to be achieved. In this regard the filter element may be cast or foamed into the frame, or the filter element and frame may be designed as one piece.

It is also possible to clamp the filter element into a frame. The frame parts may be made of plastic or metal. The frame parts may be joined together as a tongue-and-groove connection in which the filter element is clamped between the frame parts. This design allows rapid on-site installation of an assembly.

At least one seal may be associated with the support structure of the frame. When a seal is provided during manufacture, no additional installation steps are necessary when the frame is inserted into a holder. Provision of a seal which is affixed during manufacture eliminates installation steps such as gluing the seal to the frame and aligning the seal to fit.

The support structure and the seal may be designed as one piece. The seal may be designed as a tapered region of the support structure. The seal in particular may be designed as a sealing lip, which due to its material strength may be easily deformed and pressed against a surface. This particular design allows a design of the support structure composed of a single material, and ensures particular seal-tightness since boundary surfaces between the seal and the support structure may be omitted.

At least one seal may be joined to the support structure in a positive-fit manner. The positive-fit connection allows the seal to be affixed without using adhesive. Provision of a seal holder allows the installer to easily and precisely place a seal in a defined manner, which is necessary for optimal seal-tightness.

In this regard the support structure may have a recess for pressing in the seal. The recess may be designed as a rectangular groove or a dovetail groove. A solid, compressible seal may be pressed into the groove in such a way that the seal is joined to the support structure in a positive-fit manner.

The support structure may be composed of at least one foamed material. This particular design allows a filter element to be foamed into the support structure during manufacture of the support structure. This ensures a particular seal-tightness between the support structure and the filter element. Polyurethane foam may be used as a material for the foaming process, since this material is economical and is easily processed.

The support structure may be made of at least one injection-molded material. It is possible for the support structure to be composed of two components which are molded to one another. The support structure may be composed of a more rigid material and a seal, molded on in one piece, which may be made of a softer material. The support structure may be composed of polyamide, and the molded-on seal may be composed of a thermoplastic elastomer. In this method it is also advantageously possible to join the support structure to the filter element in a material-fit manner, thus ensuring a particular seal-tightness between the support structure and the filter element.

The support structure may be composed of nonwoven fabric. The structure of the nonwoven fabric may be compacted by thermal treatment in such a way that it has the necessary rigidity for effectively affixing a filter element in a holder. This particular embodiment allows design of an assembly comprising a frame and filter element composed of a single material. In this regard it is possible in particular for multiple filter elements to be adjacently situated and pressed together by thermal treatment in such a way that a support structure is defined by the mutually contacting opening regions of the filter elements.

The frame may include a support structure having a rectangular design. This particular design allows a checkerboard-like assembly of multiple support structures in a so-called filter house, in which support structures having filter elements are situated next to and on top of one another in multiple rows and columns. The support structures usually have a square design.

The support structure may include braces. It is possible in particular for the braces and the support structure to be designed in one piece in the form of a grid. The braces advantageously allow the support structure to be joined to the planar layers of a filter element. The braces ensure that multiple filter elements may be adjacently situated, the filter elements being fixed by means of a bond between the braces and the planar layers.

All embodiments of the support structure discussed in conjunction with the assembly are also possible for a single frame which includes such a support structure. In this regard a frame as such, independent of the assembly and the filter element, is also provided which may include a support structure according to one of the described designs.

A layer may have a deep-drawn area. Layers having deep-drawn areas are characterized by a particular flexural strength and a high section modulus which resists twisting. These layers may be used in the manufacture of respirator masks, star filters for liquid filtration, or cartridge filters, since these products must have high torsional rigidity in places to ensure fitness for use.

In addition, layers having deep-drawn areas may be folded in a zig-zag pattern to increase their effective filtering surface. Such layers may be used in cartridge filters. The deep-drawn areas may have sufficient rigidity to ensure spacing between the folded edges or folded layer regions during operation. The folding may be simplified by using deep-drawn line structures and specifying the position of the folded edges when the line structures form the folded edges.

Deep-drawn areas may be embossed on a planar layer by the fact that two embossing platforms accommodate the layer in between. The embossing platforms may have projecting, heatable oblong elements which have rounded, curved surfaces. When the embossing platforms are brought together, the oblong elements stretch or pull the heated layer into interspaces which are formed between the elements, which are situated in an offset manner. The heated elements soften and deform thermoplastic fibrous material. The deformation is “frozen in,” in a manner of speaking, after the fibrous material is chilled. In this manner an undulating or curved pattern is associated with the layer by means of a deep-drawing process. At the same time, line structures may be applied to the layer during a deep-drawing process in order to simplify folding of the layer.

Besides thermoplastic fibers, the layers described herein may also include cellulose fibers. Cellulose fibers are characterized by favorable costs. In addition, aramid fibers, which are characterized by high temperature stability, may be admixed.

The layers described herein may be used in surface filtration when the layers are particularly amenable to cleaning. The layers described herein may have a progressive design for application in deep bed filtration. A progressive design is characterized by provision of coarse pores, followed by fine pores, in one direction in a filter layer.

Various possibilities exist for advantageously embodying and refining the teaching of the present invention. Reference is made to the subordinate claims and to the following discussion of preferred exemplary embodiments of the filter element or the assembly according to the invention. In conjunction with the explanation of the preferred exemplary embodiments with reference to the drawings, a general discussion of preferred embodiments and refinements of the teaching is also provided.

### BRIEF DESCRIPTION OF THE DRAWINGS

The drawings show the following:

FIG. 1 shows a top view of a filter element having means with a curved shape;

FIG. 1a shows a cross-sectional view of the filter element according to FIG. 1;

FIG. 2 shows a top view of a filter element having curved and planar regions;

FIG. 2a shows a cross-sectional view of the filter element according to FIG. 2;

FIG. 3 shows an assembly having a frame and a filter element;

FIG. 4 shows a support structure with which two seals are associated;

FIG. 5 shows a support structure with which a U-shaped seal is associated; and

FIG. 6 shows a support structure having a recess for accommodating a seal.

### DETAILED DESCRIPTION OF THE INVENTION

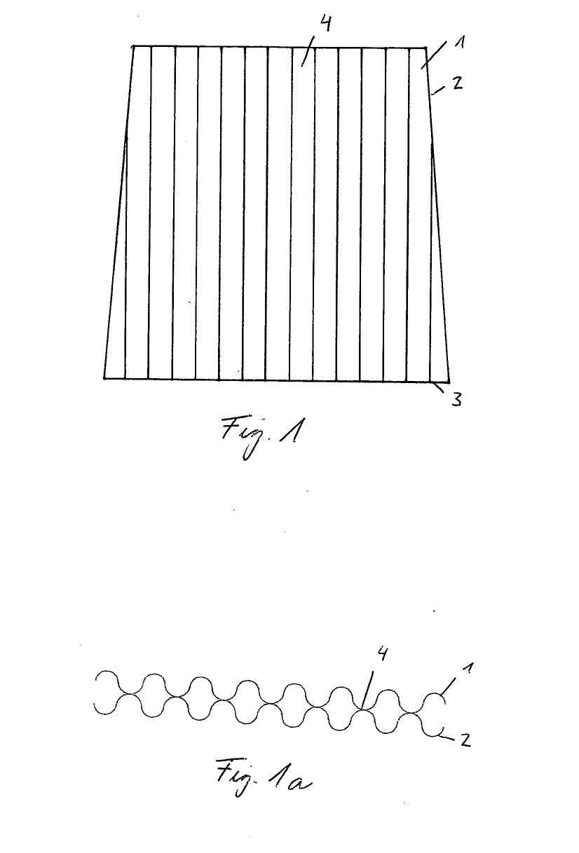

FIG. 1 shows a filter element which comprises a first planar layer 1 and a second planar layer 2, the layers 1, 2 being joined to one another to form a volume and an opening 3. The layers 1, 2 are spaced apart from one another by means 4. The means 4 are formed from at least one layer 1, 2.

FIG. 1a shows the layers 1, 2 according to FIG. 1, the layers having curved planar regions 4. The means 4 are formed from both layers 1, 2. The means 4 join the layers 1, 2 to one another. The means 4 are designed as deep-drawn areas. The means 4 are designed as three-dimensional structures which project from a flat, planar layer 1, 2.

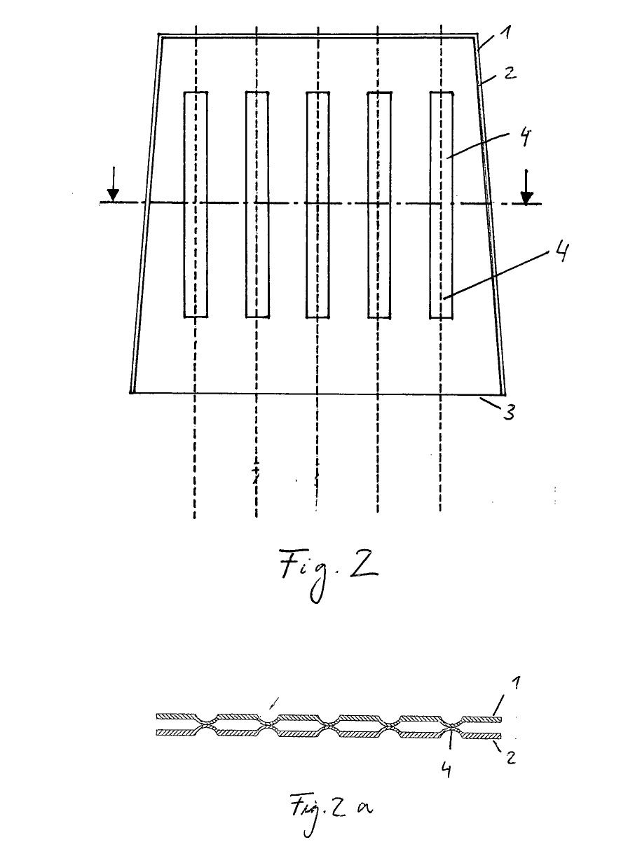

FIG. 2 shows a filter element which is composed of planar layers 1, 2, from which curved means 4 are formed.

FIG. 2a shows the filter element according to FIG. 2 in a cross-sectional view. The layers 1, 2 are joined to one another via the curved means 4. The curved means 4 are adjoined by planar regions of the layers 1, 2, which together with the curved means 4 form the chambers or channels of the filter element.

The layers 1, 2 according to FIG. 1 and FIG. 2 have a trapezoidal shape, and are joined together at three sides. Said layers define an opening 3.

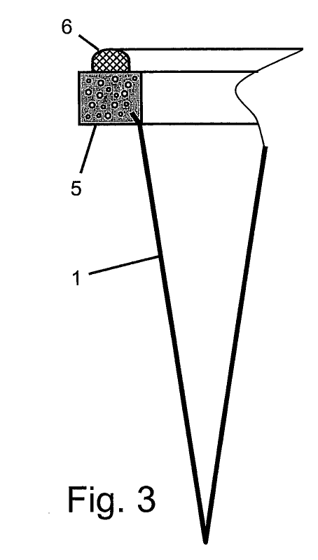

FIG. 3 shows an assembly having a frame for accommodating a filter element, according to FIG. 1 or FIG. 2, which includes a support structure 5. A seal 6 is associated with the support structure 5.

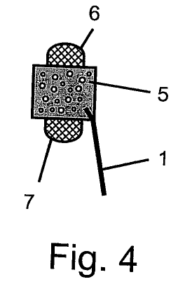

FIG. 4 shows the frame 5 together with a seal 6, and a seal 7 which is situated on the opposite sides of the frame. The seal 6 or 7 may also be provided alone at one of the sides of the support structure 5, or seals may be provided on three sides of the support structure 5.

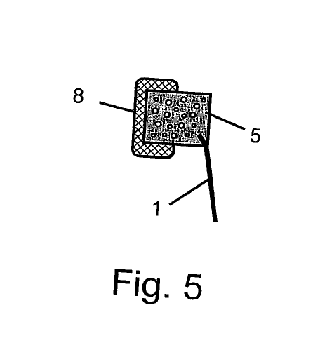

FIG. 5 shows a U-shaped seal 8 which lies against the support structure on three sides.

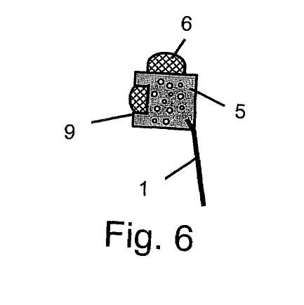

FIG. 6 shows the support structure together with a recess 9. The recess 9 has a rectangular shape, and is used for positive-fit accommodation of a seal.

All of the frames or support structures 5 described in FIGS. 3 through 6 may be combined with the filter elements according to FIGS. 1 and 2.

With regard to further advantageous embodiments and refinements of the teaching according to the invention, reference is made to the general portion of the description and to the accompanying claims.

In conclusion, it is emphasized in particular that the previous exemplary embodiments, selected in a completely arbitrary manner, are used solely to explain the teaching according to the invention, which, however, is not limited to said exemplary embodiments.

What is claimed is:

1. A filter element comprising a first planar layer and a second planar layer, the layers being joined to one another to form at least one volume and at least one opening, and the layers being spaced apart from one another in places by means, wherein the means are formed from at least one layer.

2. The filter element according to claim 1, wherein the means are formed from both layers.

3. The filter element according to claim 1, wherein the means join the layers to one another, at least in places.

4. The filter element according to claim 1, wherein the means are designed as deep-drawn or embossed areas.

5. The filter element according to claim 1, wherein the means are designed as planar areas.

6. The filter element according to claim 1, wherein the means are designed as three-dimensional structures which project from a flat, planar layer.

7. The filter element according to claim 1, wherein the means have a curved shape.

8. The filter element according to claim 1, wherein the layers are produced from nonwoven fabric.

9. The filter element according to claim 8, wherein the nonwoven fabric includes thermoplastic fibers.

10. The filter element according to claim 8, wherein the nonwoven fabric includes activated carbon or activated carbon granules.

11. The filter element according to claim 1, wherein the layers have a rectangular or trapezoidal shape, and are joined together at three sides.

12. The filter element according to claim 1, wherein the layers are welded together.

13. The filter element according to claim 1, wherein the layers are glued together.

14. A system comprising a filter element according to claim 1, and a frame having a support structure.

15. The system according to claim 14, wherein the frame and the filter element are undetachably joined to one another.

16. The system according to claim 14, wherein the filter element is cast or foamed into the frame.

17. The system according to claim 14, wherein the frame and the filter element are designed as one piece.

18. The system according to claim 14, wherein at least one seal is associated with the support structure.

19. The system according to claim 18, wherein the support structure and the seal are designed as one piece.

20. The system according to claim 19, wherein the seal is designed as a tapered region of the support structure.

21. The system according to claim 14, wherein at least one seal may be joined to the support structure in a positive-fit manner.

22. The system according to claim 14, wherein the support structure has a recess for pressing in a seal.

23. The system according to claim 14, wherein the support structure is composed of at least one foamed material.

24. The system according to claim 14, wherein the support structure is composed of at least one injection-molded material.

25. The system according to claim 14, wherein the support structure is composed of nonwoven fabric.

26. The system according to claim 14, wherein the support structure has a rectangular shape.

27. The system according to claim 14, wherein the support structure includes braces.

28. (canceled)
